(19) United States
(12) Patent Application Publication
(10) Pub. No.: US 2004/0064703 A1
(43) Pub. Date: Apr. 1, 2004

(54) Access control technique using cryptographic technology

(75) Inventor: Ikuo Makita, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/659,335

(22) Filed: Sep. 11, 2003

(30) Foreign Application Priority Data
Sep. 13, 2002 (JP) 2002-269115

(51) Int. Cl. H04L 9/00

(52) U.S. Cl. 713/176

(57) ABSTRACT

This invention relates to an access control by using the cryptographic technology. The method according to this invention comprises receiving a first digital signature for specific data from a user terminal; comparing the received first digital signature with a second digital signature, which is registered in a data storage unit so as to correspond to the specific data; if it is judged that the first and second digital signatures are identical, granting the user an authority to update the specific data; if it is judged that the first and second digital signatures are not identical, generating first hash data from the first digital signature; comparing the first hash data with second hash data, which is registered in the data storage unit so as to correspond to the specific data; and if it is judged that the first and second digital signatures are identical, granting the user an authority to read the specific data.

### TECHNICAL FIELD OF THE INVENTION

This invention relates to an access control technique using the cryptographic technology.

### BACKGROUND OF THE INVENTION

Hitherto, in a case where the user's access authority is managed in a database or the like, a technique is normally used in which data describing the access policy for each record or record set is registered, and when the user's access occurs, “read” or “update” is allowed for the user based on the data describing the access policy. On the other hand, the cryptographic technology is normally used to conceal the content of the communication among two or more users, to confirm existence of the alternation by using the digital signature, or the like. Incidentally, the normal cryptographic techniques are described in JP-A-2001-44988 and JP-A-2000-306026.

Although important information is encrypted and the digital signature thereof is further attached to confirm the existence of the alteration in a case where the important information is communicated, the access authority of each user for the important information is also important in a case where the important information is managed in a center system.

### SUMMARY OF THE INVENTION

Therefore, an object of this invention is to provide an access control technique using the cryptographic technology.

An information processing method in a center system according to a first aspect of this invention comprises the steps of: receiving and storing into a storage device, a first digital signature for specific data and data concerning a first user to be allowed to read the specific data, from a terminal of a second user; comparing the received first digital signature with a second digital signature, which is registered in a data registering unit so as to correspond to the specific data; and if it is judged that the first signature and the second signature are identical, carrying out a processing for enabling the first user to read the specific data. Thus, an authority to give another user browsing permission is granted to a user who holds the genuine digital signature for the specific data.

In addition, the aforementioned carrying step may comprise a step of transmitting hash data, which is registered in the data registering unit so as to correspond to the specific data, to the first user. Although it is possible to directly transmit the specific data to the terminal of the first user who is enabled to browse the specific data, here, the hash data is transmitted to the terminal of the first user. Then, as described below, in response to an access request including a digital signature that is generated from the hash data, it is judged whether it is possible to browse the specific data, and if possible, the specific data is transmitted to the first user.

Furthermore, the first aspect of this invention may further comprise the steps of: if it is judged that the first digital signature and the second digital signature are not identical, generating and storing into the storage device, second hash data from the first digital signature; comparing the second hash data with the hash data, which is registered in the data registering unit so as to correspond to the specific data; and if it is judged that the second hash data and the hash data are identical, carrying out a processing for enabling the first user to read the specific data. Thus, an authority to give another user browsing permission is granted to a user who holds the genuine hash data for the specific data.

An access authority management method in a center system according to a second aspect of this invention comprises: receiving and storing into a storage device, a first digital signature for specific data from a terminal of a user; comparing the received first digital signature with a second digital signature, which is registered in a data registering unit so as to correspond to the specific data; and if it is judged that the first digital signature and the second digital signature are identical, carrying out a setting to grant the user an authority to update the specific data.

Thus, an authority to update the specific data is granted to a user who holds the genuine digital signature for the specific data, and for example, it is granted to send the specific data to the user terminal in such a mode that updating is enabled, and/or to register the updated data.

In addition, the access authority management method according to the second aspect of this invention may further comprise the steps of: if it is judged that the first digital signature and the second digital signature are not identical, generating and storing into the storage device, first hash data from the first digital signature; comparing the first hash data with second hash data, which is registered in the data registering unit so as to correspond to the specific data; and if it is judged that the first hash data and the second hash data are identical, carrying out a setting to grant the user an authority to read the specific data. Thus, the authority to read is granted to the user who holds the genuine hash data for the specific data, and for example, the specific data is transmitted to the user terminal in such a mode that only browsing is enabled.

Furthermore, the access authority management method according to the second aspect of this invention may further comprise a step of, if it is judged that the first hash data and the second hash data are not identical, transmitting an access denial notice to the user terminal.

A data registration method in a center system according to a third aspect of this invention comprises the steps of: if specific data is received from a user terminal, generate and storing into a storage device, hash data for the specific data; transmitting the hash data to the user terminal; receiving and storing into the storage device, a digital signature generated from the hash data; and registering the specific data, the hash data and the digital signature into a data registering unit. Thus, the data registration is carried out, and thereby the preparation of later usages (for example, browsing, updating and the like) is carried out.

A data access method in a user system according to a fourth aspect of this invention comprises the steps of: generating and storing into a storage device, a digital signature from hash data, which is stored in a hash storage, for specific data; transmitting an access request including the digital signature to a server; and if the digital signature and a second digital signature, which is registered in the server, for the specific data are identical, receiving and displaying on a display device, the specific data in a state where updating is enabled, from the server. If the genuine digital signature can be generated, it becomes possible to update the specific data.

In addition, the data access method according to the fourth aspect of this invention may further comprise a step of, if the digital signature and the second digital signature, which is registered in the server, for the specific data are not identical, but hash data generated from the digital signature and second hash data, which is registered in the server, for the specific data are identical, receiving and displaying on a display device, the specific data from the server in a state where only reading is possible. When the digital signature has any difference, but the genuine hash data is held, the reference to the specific data is enabled.

Incidentally, the information processing method, the access authority management method, the access method and the data registering method according to this invention may be carried out by programs and computer hardware, and the programs may be stored in a storage medium or storage device, such as flexible disk, CD-ROM, magneto-optical disk, semiconductor memories, hard disk, or the like. In addition, they may be distributed via a network. Incidentally, an intermediate processing result is temporarily stored into a memory.

### BRIEF DESCRIPTION OF THE DRAWINGS

FIG. 1 is a diagram showing a system outline according to an embodiment of this invention;

FIG. 2A and 2B are diagrams showing an example of data stored in the electronic certificate storage;

FIG. 3 is a diagram showing an example of data stored in a hash storage;

FIG. 4A, 4B and 4C are diagrams showing an example of data stored in a trade document master storage;

FIG. 5 is a diagram showing an example of a file configuration;

FIG. 6 is a diagram showing a processing flow for registering the trade document data;

FIG. 7 is a diagram showing an example of data stored in a temporal digital signature storage;

FIG. 8 is a diagram showing a processing flow for enabling to read the trade document data;

FIG. 9 is a diagram showing an example of a message to enable to read the trade document data;

FIG. 10 is a diagram showing a processing flow for confirming an access authority; and

FIG. 11 is a diagram showing an example of a message for an access request.

### DETAILE DESCRIPTION OF THE PREFERRED EMBODIMENTS

1. Outline

For example, the foreign trade business has a characteristic in which a trade chain for one trade transaction is composed of a lot of companies, whose maximum number is 27, more than 40 kinds of trade documents are created in the business process as the occasion demands, and those are circulated from hand to hand among companies. For example, in the customs clearance request process performed by the owner of the goods, the owner creates an invoice and packing list, and sends them a forwarder. The forwarder further creates a shopping advice, and sends it the owner. That is, at the end of the aforementioned process, the owner holds the originals of the invoice and packing list, and a copy of the shipping advice among the trade documents. In addition, the forwarder holds copies of the invoice and shipping list, and the original of the shipping advice. Thus, a plurality of companies creates a plurality of trade documents, and hold the same documents (i.e. the original and copy).

Because of such a characteristic of the foreign trade business, a configuration is adopted in which a system is provided in a united center and the trade documents are managed in the united center system. Then, in this embodiment, data actually communicated among companies is limited to access control information to the trade document data managed in the united center system. As described below, a hash value (also described as hash data) of the trade document is used as the access control information. In addition, a digital signature of the trade document is also used as the access control information for the united center system. Such a configuration enables the system resources to be effectively used based on the efficient data storage and management, and the reduction of the transaction data volume and network loads and shortening of the transmission time are achieved.

Specifically, only a document creator holds an authority to update the circulated trade document data, and an authority to only read the trade document data is granted to a destination of the trade document data (further including a next destination and etc.). By carrying out the access control to the trade document data managed in the united center system based on the digital signature and hash value of the trade document data, the control of the updating and browsing authority to the trade document data is achieved. Thereby, as compared with the conventional method that manages flags in the access control table or the like, a remarkable improvement is achieved in the security aspect. In addition, since it is unnecessary to store an access policy for each trade document in the united center system, the flexible access control is possible.

2. Embodiments

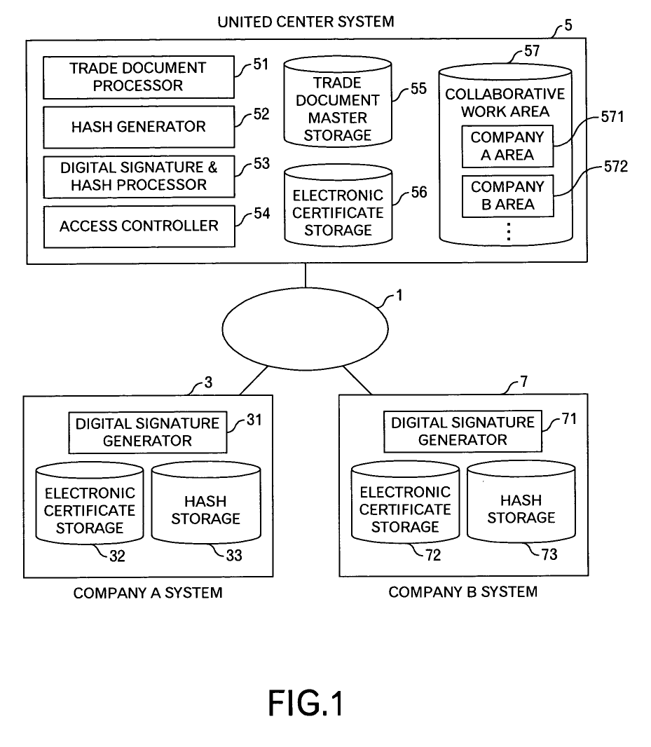

A system outline according to an embodiment of this invention will be explained by using FIG. 1. A network 1 such as the Internet is connected with a company A system 3, united center system 5 and company B system 7. For convenience of the explanation, only two systems are shown in FIG. 1, but a lot of company's systems are connected to the network 1.

The company A system 3 has a web browser function, and can carry out the cryptographic communication with the united center system 5. Then, it has a digital signature generator 31 for generating a digital signature by encrypting hash data with a secret key in the public key cryptography, an electronic certificate storage 32 for storing its own electronic certificate, an electronic certificate of the united center system 5 and the like, and a hash storage 33 for storing received hash data of the trade document data from the united center system 5.

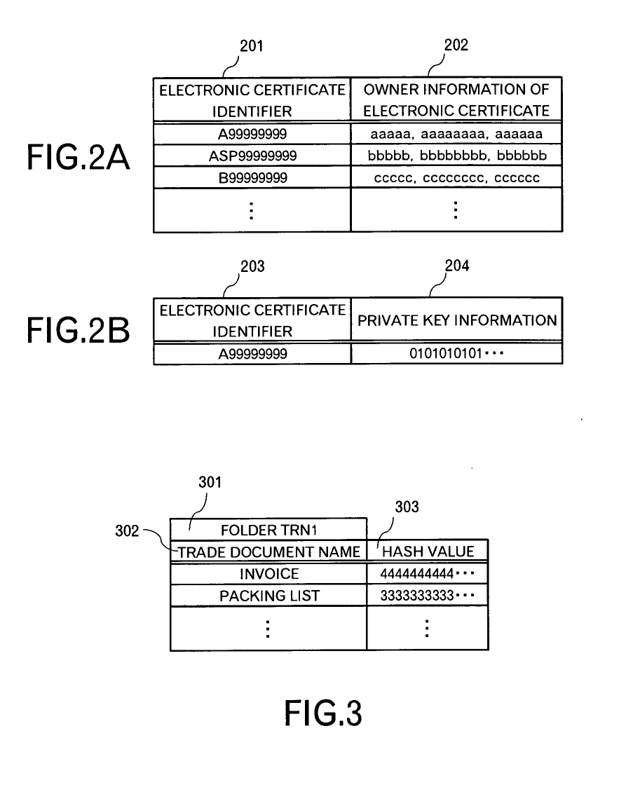

FIG. 2A and 2B show an example of data stored in the electronic certificate storage 32. As shown in FIG. 2A, the electronic certificate storage 32 stores electronic certificate identifiers 201 (for example, issuance number) of the electronic certificates of the company A and others, and owner information (for example, owner's name and/or his or her public key) of the electronic certificates so as to correspond to each other. In addition, as shown in FIG. 2B, it stores the electronic certificate identifier 203 (for example, issuance number) of the company A's electronic certificate and a private key information 204 of the company A so as to correspond to each other.

FIG. 3 shows an example of data stored in the hash storage 33. As shown in FIG. 3, in the hash storage 33, a folder 301 is provided for each transaction number that is identification information, such as TRN 1 in FIG. 3, and a hash value 303 is registered so as to correspond to the trade document name 302. In the example of FIG. 3, a hash value “44444 . . . ,” is registered so as to correspond to the trade document name “invoice”, and a hash value “33333 . . . ” is registered so as to correspond to the trade document name “packing list”.

The company B system 7 has a web browser function, and can carry out the cryptographic communication with the united center system 5. Then, it has a digital signature generator 71 for generating a digital signature by encrypting hash data with a secret key in the public key cryptography, an electronic certificate storage 72 for storing its own electronic certificate, an electronic certificate of the united center system 5 and the like, and a hash storage 73 for storing received hash data of the trade document data from the united center system 5. The format of data stored in the electronic certificate storage 72 is the same as shown in FIG. 2A and 2B. The format of data stored in the hash storage 73 is the same as shown in FIG. 3.

The united center system 5 has a web server function, and can carry out the cryptographic communication with the company A system 3 and company B system 7. Then, it has a trade document processor 51, a hash generator 52 for generating hash data according to a predetermined hash function from a trade document file, a digital signature and hash processor 53 for carrying out a collation processing of the digital signatures and hash values, and the like, an access controller 54 for carrying out the access control to the trade document file based on the collation processing result, a trade document master storage 55 for storing a trade document file, a digital signature and hash data for each trade document of each transaction, an electronic certificate storage 56 for storing the electronic certificates of the united center system 5 and user companies, and a collaborative work area 57 that is a work area used in the collaborative processing with user companies.

The trade document processor 51 receives trade document data from the system of the trade document creator, generates a trade document file from the received trade document data, stores it into the collaborative work area 57, registers it in the trade document master storage 55, converts the trade document file stored in the trade document master storage 55 into data in an appropriate display mode in a case where an access to the trade document is allowed.

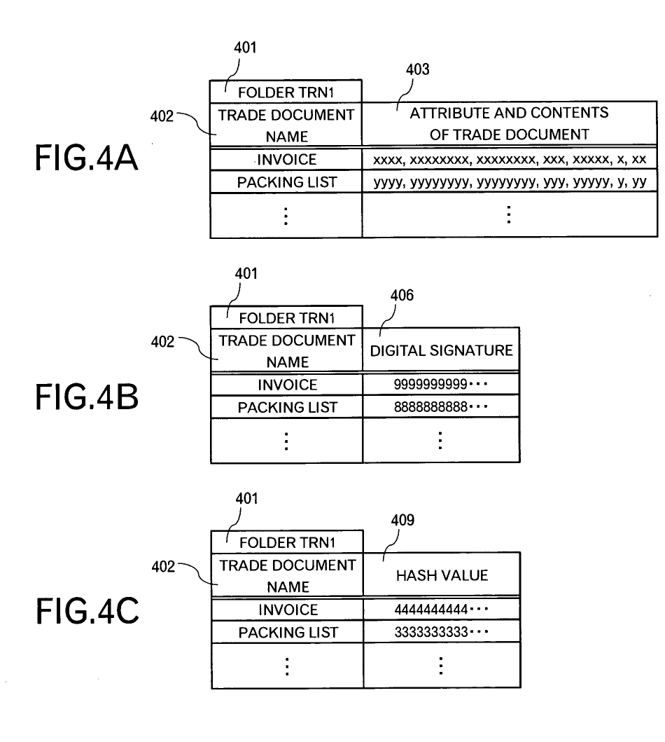

FIGS. 4A, 4B and 4C shows an example of data stored in the trade document master storage 55. As shown in FIG. 4A, in the trade document master storage 55, a folder 401 is provided for each transaction number that is identification information, such as TRN1 in the example of FIG. 4A, and the attributes and contents 403 of the trade document are registered so as to correspond to the trade document name 402. In addition, as shown in FIG. 4B, in the folder 401 provided for each transaction number, the digital signature 406 is also registered so as to correspond to the trade document name 402. Furthermore, as shown in FIG. 4C, in the folder provided for each transaction number, a hash value 409 is also registered so as to correspond to the trade document name 402.

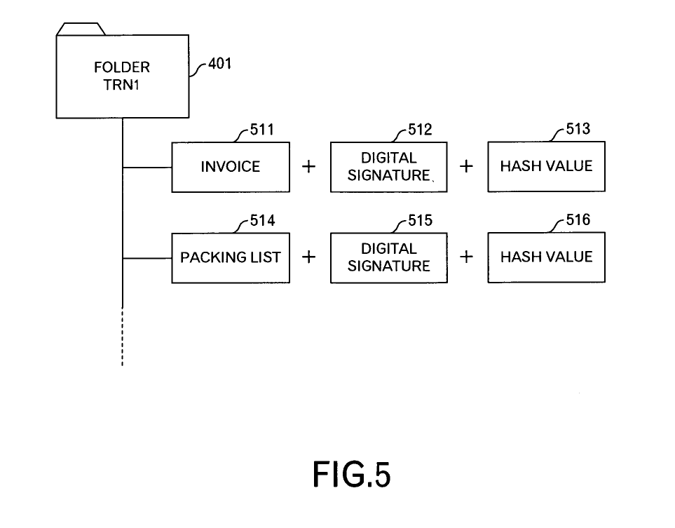

Such a table configuration can be shown as a file structure diagram in FIG. 5. In an example of FIG. 5, the folder 401 is provided for each transaction number, and the folder 401 includes an invoice file 511 that is a trade document file associated with the transaction, a digital signature 512 of the invoice file 511, hash value 513 of the invoice file 511, packing list file 514 that is a file of the trade document associated with the transaction, digital signature 515 of the packing list file 514, and hash value 516 of the packing list file 514.

Incidentally, the format of the data stored in the electronic certificate storage 56 is the same as shown in FIG. 2A and 2B. In addition, the collaborative work area 57 includes a work area for each company, such as a company A area 571, and a company B area 572.

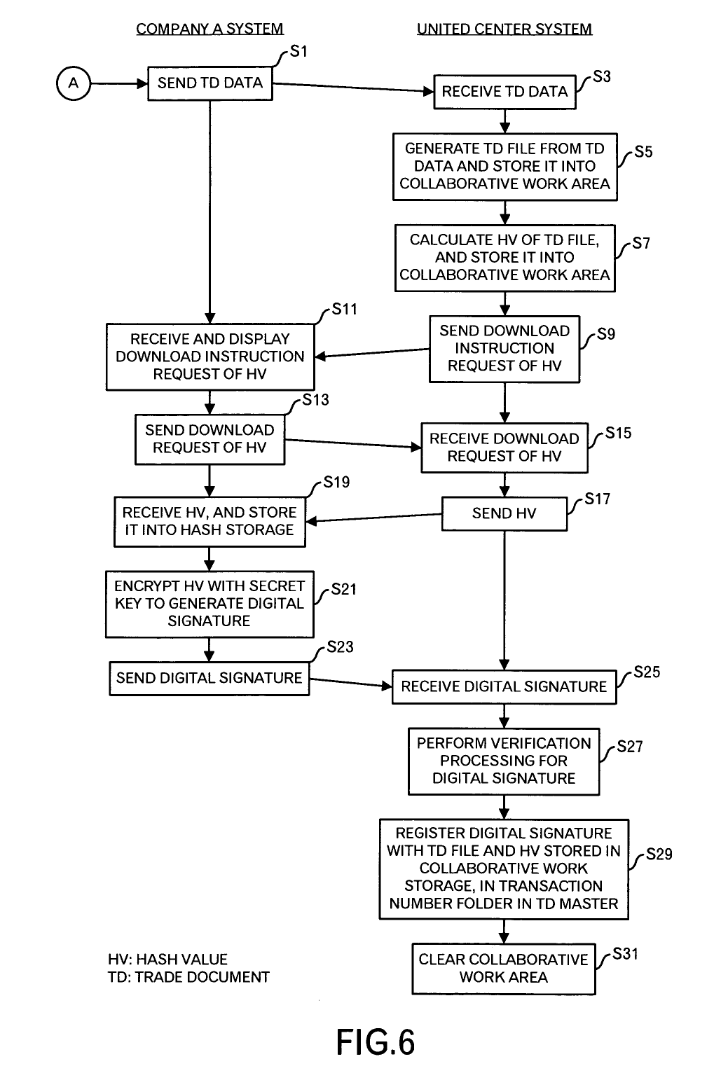

Next, an operation of the system shown in FIG. 1 will be explained by using FIG. 6 to FIG. 11. Incidentally, in the following explanation, the communication between systems is normally encrypted, and the descriptions about the encryption and verification in each step are omitted. In addition, the company A and B hold the electronic certificate of the united center, and the united center holds the electronic certificates of the company A and B. According to circumstances, there is a case where its own electronic certificate is attached and transmitted each time.

First, a registration processing of the trade document data will be explained by using FIG. 6. Incidentally, the company A creates the trade document. For example, the company A system 3 displays a page data for registering the trade document data, which is received from the united center system 5, and prompts a user of the company A system 3 to input data into data input columns. When the user of the company A system 3 inputs data into the data input columns and instructs data transmission, the company A system 3 transmits the input trade document data to the united center system 5 (Step S1). The united center system 5 receives the trade document data from the company A system 3 (Step S3), and then the trade document processor 51 generates a trade document file from the trade document data, and stores it into the company A area 571 in the collaborative work area 57 (Step S5). Next, the hash generator 52 calculates a hash value of the trade document file stored in the company A area in the collaborative work area 57, and stores the hash value into the company A area 571 of the collaborative work area (Step S7).

When the hash value is calculated, the united center system 5 transmits a download instruction request of the hash value to the company A system 3 (Step S9). The company A system 3 receives the download instruction request of the hash value from the united center system 5, and displays it on a display device (Step S11). When the user of the company A system 3 inputs a download instruction in response to this display, the company A system 3 transmits the download request of the hash value to the united center system 5 (Step S13). The united center system 5 receives the download request of the hash value from the company A system 3 (Step S15), and then reads out the hash value from the company A area 571 in the collaborative work area 57, and transmits it with information of the transaction number and trade document name to the company A system 3 (Step S17). The company A system 3 receives the hash value with the information of the transaction number and trade document name, and then registers the hash value in a folder of the transaction number in the hash storage 33 so as to correspond to the trade document name (Step S19). Incidentally, if the folder of the transaction number has not been generated, it is generated at this step.

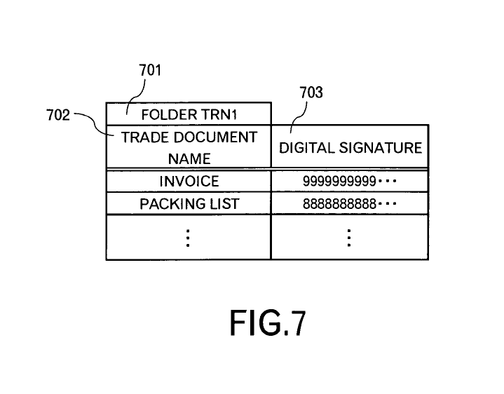

Next, the digital signature generator 31 of the company A system 3 encrypts the received hash value with its own secret key stored in the electronic certificate storage 32 to generate the digital signature (Step S21). The digital signature is stored in a temporal digital signature storage. For example, as shown in FIG. 7, a folder 701 of the transaction number is provided, and the generated digital signature 703 is registered so as to correspond to the trade document name 702. Then, the company A system 3 transmits the generated digital signature with the information of the transaction number and the trade document name to the united center system 5 (Step S23). Incidentally, the generated digital signature is deleted at the completion of the transmission for preventing burglary and so on.

The united center system 5 receives the digital signature with the information of the transaction number and trade document name from the company A system 3 (Step S25), and the digital signature and hash processor 53 carries out a confirmation processing for the received digital signature (Step S27). In this step, the digital signature is decrypted with the public key of the company A, which is stored in the electronic certificate storage 56, to generate a hash value, and it is compared with the corresponding hash value stored in the company A area 571 in the collaborative work are 57. If both of the hash values are identical, it means that the genuine digital signature is received. Therefore, the trade document processor 51 registers the trade document file and hash value stored in the company A area 571 in the collaborative work area 57, and the received digital signature in a transaction number folder in the trade document master storage 55 (Step S29). Then, it clears the company A area 571 in the collaborative work area 57 (Step S31). That is, the trade document data and hash value, which corresponds to the received digital signature, are deleted.

When the processing is carried out as described above, with the registration of the trade document data, the hash value and digital signature can also be registered in the united center system 5. Incidentally, since the hash value is generated in the united center system 5, the verification processing performed based on the hash value, and it is guaranteed that the appropriate digital signature is registered so as to correspond to the trade document file.

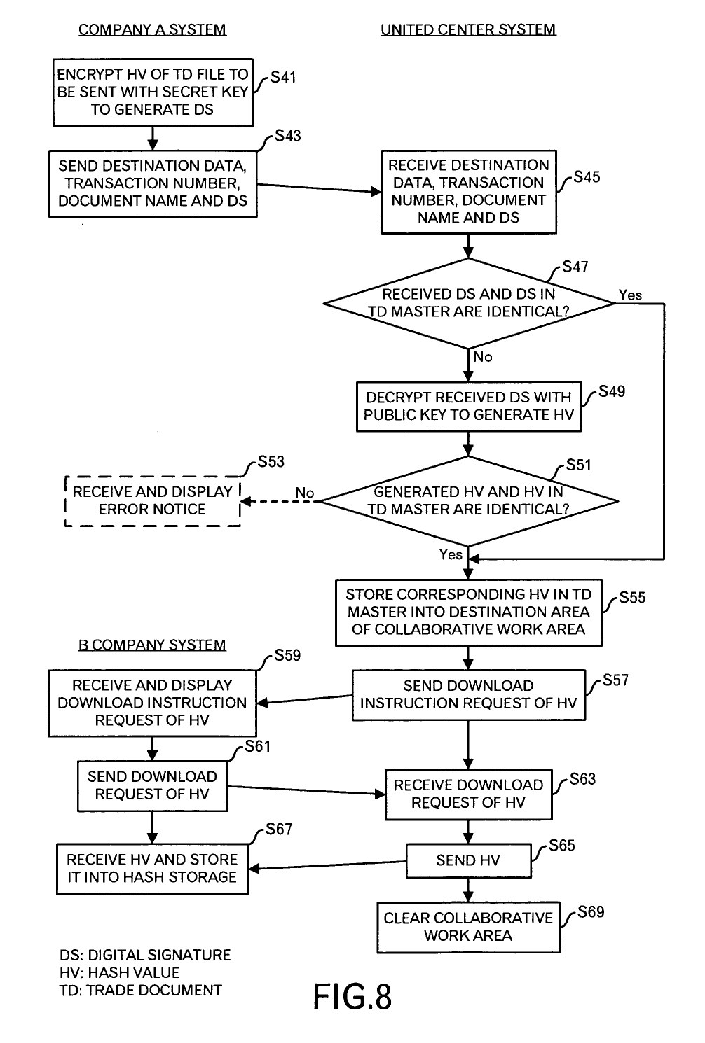

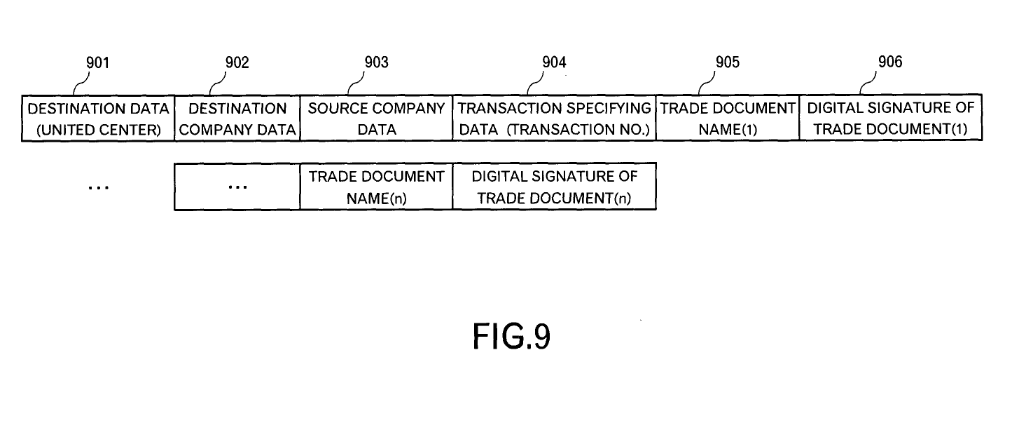

Next, a processing when the company A requests the united center system 5 to transmit the trade document to the company B will be explained by using FIG. 8 and 9. When the transaction number, trade document name and destination of the trade document to be sent is designated by the user of the company A system 3, for example, the digital signature generator 31 of the company A system 3 reads out the hash value of the trade document file to be sent, from the hash storage 33, encrypts the hash value with the secret key of the company A, which is stored in the electronic certificate storage 32, to generate the digital signature (Step S41). The digital signature is stored in a temporal digital signature storage as shown in FIG. 7. Then, the company A system 3 transmits the destination data, transaction number, trade document name and digital signature to the united center system 5 (Step S43). For example, FIG. 9 shows an example of the format of a message transmitted at the step S43. In an example of FIG. 9, a destination data 901, which is an address of the united center system 5, destination company data 902, which is, for example, a destination company ID, source company data 903, which is, for example, a source company ID, transaction specifying data 904, which is a transaction number, first trade document name 905, first digital signature 906 of the first trade document file, and so on. As shown in FIG. 9, several digital signatures can be transmitted one time.

The united center system 5 receives the destination data, transaction number, trade document name and digital signature from the company A system 3, and temporarily stores them into storage device (Step S45). Then, the digital signature and hash processor 53 compares the received signature with the digital signature that is specified by the transaction number and trade document name and registered in the trade document master storage 55 to judge if they are identical (Step S47). If it is judged that both of the digital signatures are identical, the processing shifts to step S55. When the company A is a trade document creator, the processing shifts from the step S47 to S55. On the other hand, if it is judged that they are not identical, the digital signature and hash processor 55 decrypts the received digital signature with the public key of the source company, which is stored in the electronic certificate document storage 56, to generate a hash value, and stores it into the storage device (Step S49).

Then, the digital signature and hash processor 53 compares the generated hash value with the hash value that is specified by the transaction number and the trade document name and registered in the trade document master storage 55 to judge if they are identical (Step S51). If both of the hash values are not identical, the united center system 5 transmits an error notice to the company A system 3. The company A system 3 receives the error notice from the united center system 5, and displays it on the display device (Step S53). By this notice, the user of the company A system 3 can recognize that the transmission of the trade document to the company B, which is the destination of the trade document, is not allowed because of some reason.

On the other hand, if it is judged that both of the hash values are identical, or if it is judged at the step S47 that both of the digital signatures are identical, the digital signature and hash processor 53 reads out the corresponding hash value registered in the trade document master storage 55, and stores it into the company B area in the collaborative work area 57 (Step S55). The company B is the destination of the trade document. Then, the united center system 5 transmits a download instruction request of the hash value, which is addressed to the company B, via e-mail, for example (Step S57). The company B system 7 receives the download instruction request of the hash value from the united center system 5, and displays it on the display device (Step S59). When a user of the company B instructs the download of the hash value, the company B system 7 transmits the download request of the hash value to the united center system 5 (Step S61). The united center system 5 receives the download request of the hash value from the company B system 7 (Step S63), and then reads out the hash value stored in the company B area 572 in the collaborative work area 57 and transmits it with information of the transaction number and trade document name to the company B system 7 (Step S65). The company B system 7 receives the information of the transaction number and trade document name, and the hash value from the united center system 5 (Step S67). On the other hand, the united center system 5 clears the company B area 572 in the collaborative work area 57 after the completion of the transmission (Step S69). Incidentally, only the transmitted hash value is deleted.

By carrying out such a processing, a company that has a proper hash value can cause the united center system 5 to transmit the hash value of the trade document file to other company. Incidentally, in this embodiment, the trade document file is not directly transmitted to the company designated as a destination, but the hash value is transmitted. As described above, after the access authority for reading or updating is confirmed by using the hash value or digital signature, the trade document is presented according to the access authority. Thus, the volume of the communicated data is reduced, and the security is heightened. In addition, the company that has a proper hash value is not only the company that created the trade document, but also companies to which the company that created the trade document gives the authority to read the trade document. Therefore, the company that has a proper hash value can grant the authority to read the trade document to other company. That is, when the authority to read the trade document is granted, the hash value of the trade document is obtained.

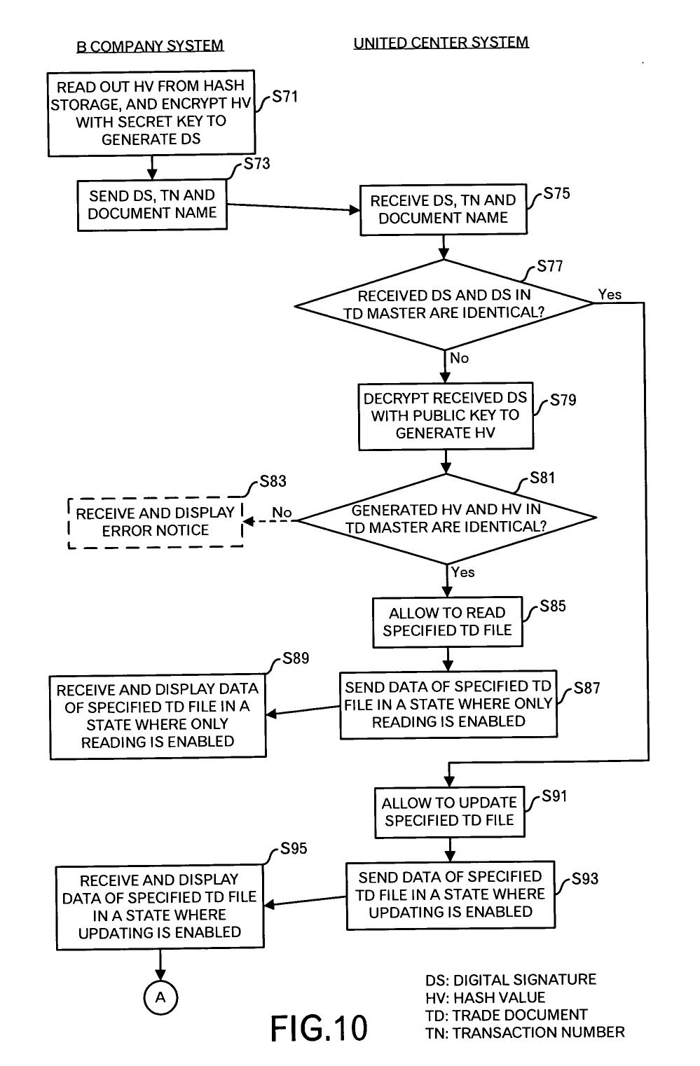

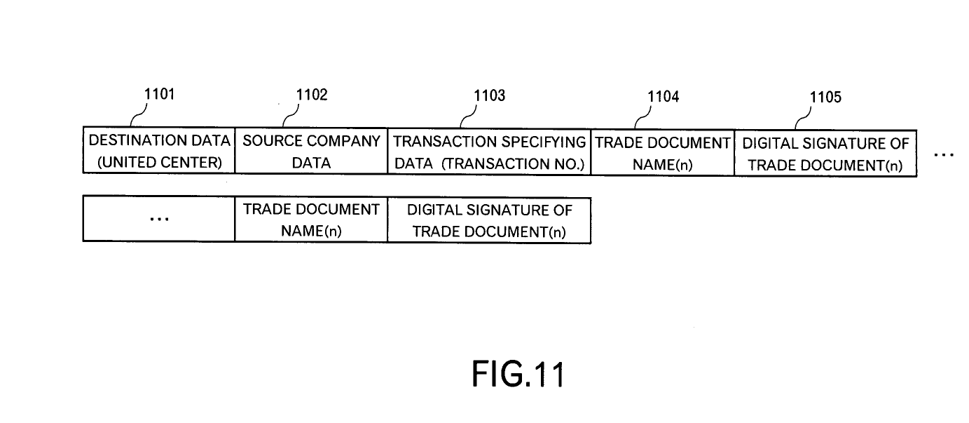

Next, a processing when the company B actually accesses the trade document will be explained by using FIG. 10 and FIG. 11. When a user of the company B specifies the transaction number and name of the trade document to be accessed, the digital signature generator 71 of the company B system 7 reads out the corresponding hash value from the hash storage 73, encrypts it with the secret key of the company B, which is stored in the electronic certificate storage 72, and temporarily stores it into the storage device (Step S71). The digital signature is stored in a temporal digital signature storage as shown in FIG. 7. Then, the company B system 7 transmits an access request including the digital signature, transaction number and trade document name to the united center system 5 (Step S73). For example, a message as shown in FIG. 11 is transmitted from the company B system 7 to the united center system. In an example of FIG. 11, the message includes destination data 1101 that is an address of the united center system 5, source company data 1102 that is an ID of the source company, transaction specifying data 1103 that is the transaction number, first trade document name 1104, first digital signature 1105 of a trade document, and so on. As shown in FIG. 11, several digital signatures can be transmitted one time.

The united center system 5 receives the access request including the digital signature, transaction number and trade document name, and temporarily stores it into the storage device (Step S75). Then, the digital signature and hash processor 53 of the united center system 5 reads out the digital signature that is specified by the transaction number and trade document name and registered in the trade document master storage 55, and judges whether the received digital signature and the read digital signature are identical (Step S77). If it is judged that both of the digital signatures are identical, since it is admitted that this access is an access originated by the creator of the trade document, an authority to update the trade document file specified by the transaction number and trade document file is allowed. Therefore, the access controller 54 carries out a setting to allow this access requester to update the trade document file specified by the transaction number and the trade document (Step S91). For example, it stores the transaction number, trade document name, ID of this access requester, and data representing “update” into the storage device for a predetermined period (for example, until he or she logs off), and allows him or her to update the specified trade document file.

Accordingly, the trade document processor 51 transmits data of the specified trade document file in a state where modification is enabled, for example (Step S93). For example, it generates page data in a form that the data of the specified trade document file is embedded into input columns, and transmits the page data to the company B system 7. The company B system receives the data of the specified trade document file in a state where modification is enabled, and displays it on the display device (Step S95). A processing after this may shift to a processing shown in FIG. 6 via terminal A, for example, and a trade document file for the updated trade document data may be generated and re-registered into the trade document master storage 55. Besides, a difference between the trade documents before and after updating may be registered as another file.

If it is judged at the step S77 that both of the digital signatures are not identical, it is determined that it is an access from a person who is not the creator of the trade document. Therefore, it is judged whether it is an access from a person who is allowed to browse the trade document. The digital signature and hash processor 53 reads out the public key of the company B from the electronic certificate storage 56, decrypts the digital signature with the public key to generate a hash value, and store it into the storage device (Step S79). Then, the digital signature and hash processor 53 reads out the hash value that is specified by the transaction number and the trade document and registered in the trade document master storage 55, and compares it with the generated hash value (Step S81). If it is judged that both of the hash values are not identical, since the access should be denied, the digital signature and hash processor 53 transmits an error notice representing the access denial to the company B system 7. The company B system 7 receives the error notice representing the access denial, and displays it on the display device (Step S83). Thus, the user of the company B can recognize that the access is rejected because of some reason.

On the other hand, if it is judged that both of the hash values are identical, since it is admitted that this access is carried by a person who is allowed to browse the trade document, the access requester is allowed to browse the trade document file specified by the transaction number and the trade document name. Therefore, the access controller 54 carries out a setting to allow to browse (i.e. read) the trade document file specified by the transaction number and the trade document name for this access requester (Step S85). For example, it stores the transaction number, trade document name, ID of this access requester, and data representing “browsing” or “reading” into the storage device for a predetermined period (for example, until he or she logs off), and allows him or her to browse the specified trade document file.

Accordingly, the trade document processor 51 transmits data of the specified trade document file in a state where only browsing is enabled, to the company B system 7, for example (Step S87). For example, it generates page data in a form that the data of the specified trade document file is included in the display columns, and transmits the page data to the company B system 7. The company B system 7 receives the data of the specified trade document file in such a mode that only browsing is enabled from the united center system 5, and displays it on the display device (Step S89). Thus, the user of the company B can confirm the data of the trade document.

By carrying out the processing as described above, the person who has only the hash value can only browse the trade document, and the person who created the trade document and has the genuine hash value can update the trade document. The hash value is distributed to various users, but the data volume is smaller than that of the trade document. Therefore, the volume of the communicated data and storage capacity can be reduced. In addition, since the digital signature obtained from the hash value is used to confirm the access authority, it is verified whether he or she has a correct secret key, and further since it can be checked whether he or she is a proper user when the hash value is generated from the digital signature, the security is heightened. Besides, if the hash value is obtained, since it is possible to at least browse, the flexibility of the access control is enhanced.

This embodiment of this invention described above is mere one example, and this invention is not limited to this embodiment. That is, an example using the trade documents were explained, but data to be access-controlled is not limited to the data of the trade document, and this embodiment can be applied to all kinds of data. Besides, functional blocks and data storages are mere examples, and the functional blocks do not necessarily correspond to actual program modules, respectively. Furthermore, the management method of data in the trade document master storage 55 is an example, and folders may not be necessarily created with the transaction number. There is a case where serial identifiers are respectively issued to all files and the relationship is managed in a database. The access to the united center system 5 may be performed after the login procedure.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. An information processing method in a center system, comprising:
receiving a first digital signature for specific data and data concerning a first user to be allowed to read said specific data, from a terminal of a second user;
comparing the received first digital signature with a second digital signature, which is registered in a data storage unit so as to correspond to said specific data; and
if it is judged that said first signature and said second signature are identical, performing a processing for enabling said first user to read said specific data.

2. The information processing method as set forth in claim 1, wherein said performing comprises transmitting hash data, which is registered in said data storage unit so as to correspond to said specific data, to a terminal of said first user.

3. The information processing method as set forth in claim 1, further comprising:
if it is judged that said first signature and said second signature are not identical, generating second hash data from said first digital signature;
comparing the generated second hash data with hash data, which is registered in said data storage unit so as to correspond to said specific data; and
executing a processing for enabling said first user to read said specific data.

4. The information processing method as set forth in claim 3, wherein said executing comprises transmitting hash data, which is registered in said data storage unit so as to correspond to said specific data, to a terminal of said first user.

5. An access authority management method in a center system, comprising:
receiving a first digital signature for specific data from a terminal of a user;
comparing the received first digital signature with a second digital signature, which is registered in a data storage unit so as to correspond to said specific data; and
if it is judged that said first digital signature and said second digital signature are identical, carrying out a setting to grant said user an authority to update said specific data.

6. The access authority management method as set forth in claim 5, further comprising:
if it is judged that said first digital signature and said second digital signature are not identical, generating first hash data from said first digital signature;
comparing said first hash data with second hash data, which is registered in said data storage unit so as to correspond to said specific data; and
if it is judged that said first hash data and said second hash data are identical, carrying out a setting to grant said user an authority to read said specific data.

7. The access authority management method as set forth in claim 6, further comprising transmitting an access denial notice to said terminal of said user, if it is judged that said first hash data and said second hash data are not identical.

8. The access authority management method as set forth in claim 5, further comprising:
if data for updating said specific data is received from said terminal of said user, generating third hash data for the updated specific data;
transmitting said third hash data to said terminal of said user;
receiving a third digital signature generated from said third hash data, from said terminal of said user; and
registering said updated specific data, said third hash data, and said third digital signature into said data storage unit.

9. The access authority management method as set forth in claim 8, further comprising:
generating fourth hash data from said third digital signature before said registering; and
comparing said fourth hash data with said third hash data, and
wherein said registering is executed if it is judged that said fourth hash data and said third hash data are identical.

10. The access authority management method as set forth in claim 6, further comprising, if said authority to read said specific data is granted to said user, transmitting said specific data in a state where only reading is enabled, to said terminal of said user.

11. A data registration method in a center system, comprising:
if specific data is received from a user terminal, generate hash data for said specific data;
transmitting said hash data to said user terminal;
receiving a digital signature generated from said hash data; and
registering said specific data, said hash data and said digital signature into a data storage unit.

12. A data access method in a user system, comprising:
generating a digital signature from hash data, which is stored in a hash storage, for specific data;
transmitting an access request including said digital signature to a server; and
if said digital signature and a second digital signature, which is registered in said server, for said specific data are identical, receiving and displaying on a display device, said specific data in a state where updating is enabled, from said server.

13. The data access method as set forth in claim 12, further comprising, if said digital signature and said second digital signature, which is registered in said server, for said specific data are not identical, but hash data generated from said digital signature and second hash data, which is registered in said server, for said specific data are identical, receiving and displaying on a display device, said specific data in a state where only reading is enabled, from said server.

14. A computer program embodied on a medium, said computer program comprising:
receiving a first digital signature for specific data and data concerning a first user to be allowed to read said specific data, from a terminal of a second user;
comparing the received first digital signature with a second digital signature, which is registered in a data storage unit so as to correspond to said specific data; and
if it is judged that said first signature and said second signature are identical, performing a processing for enabling said first user to read said specific data.

15. The computer program as set forth in claim 14, wherein said performing comprises transmitting hash data, which is registered in said data storage unit so as to correspond to said specific data, to a terminal of said first user.

16. The computer program as set forth in claim 14, further comprising:
if it is judged that said first signature and said second signature are not identical, generating second hash data from said first digital signature;
comparing the generated second hash data with hash data, which is registered in said data storage unit so as to correspond to said specific data; and
executing a processing for enabling said first user to read said specific data.

17. The computer program as set forth in claim 16, wherein said executing comprises transmitting hash data, which is registered in said data storage unit so as to correspond to said specific data, to a terminal of said first user.

18. A computer program for an access authority management, said computer program comprising:
receiving a first digital signature for specific data from a terminal of a user;
comparing the received first digital signature with a second digital signature, which is registered in a data storage unit so as to correspond to said specific data; and
if it is judged that said first digital signature and said second digital signature are identical, carrying out a setting to grant said user an authority to update said specific data.

19. The computer program as set forth in claim 18, further comprising:
if it is judged that said first digital signature and said second digital signature are not identical, generating first hash data from said first digital signature;
comparing said first hash data with second hash data, which is registered in said data storage unit so as to correspond to said specific data; and
if it is judged that said first hash data and said second hash data are identical, carrying out a setting to grant said user an authority to read said specific data.

20. The computer program as set forth in claim 19, further comprising transmitting an access denial notice to said terminal of said user, if it is judged that said first hash data and said second hash data are not identical.

21. The computer program as set forth in claim 18, further comprising:
if data for updating said specific data is received from said terminal of said user, generating third hash data for the updated specific data;
transmitting said third hash data to said terminal of said user;
receiving a third digital signature generated from said third hash data, from said terminal of said user; and
registering said updated specific data, said third hash data, and said third digital signature into said data storage unit.

22. The computer program as set forth in claim 21, further comprising:
generating fourth hash data from said third digital signature before said registering; and
comparing said fourth hash data with said third hash data, and
wherein said registering is executed if it is judged that said fourth hash data and said third hash data are identical.

23. The computer program as set forth in claim 19, further comprising, if said authority to read said specific data is granted to said user, transmitting said specific data in a state where only reading is enabled, to said terminal of said user.

24. A center system, comprising:
means for receiving a first digital signature for specific data and data concerning a first user to be allowed to read said specific data, from a terminal of a second user;
means for comparing the received first digital signature with a second digital signature, which is registered in a data storage unit so as to correspond to said specific data; and
means for performing a processing for enabling said first user to read said specific data, if it is judged that said first signature and said second signature are identical.

25. The center system as set forth in claim 24, wherein said means for performing comprises means for transmitting hash data, which is registered in said data storage unit so as to correspond to said specific data, to a terminal of said first user.

26. The center system as set forth in claim 24, further comprising:
means for generating second hash data from said first digital signature, if it is judged that said first signature and said second signature are not identical;
means for comparing the generated second hash data with hash data, which is registered in said data storage unit so as to correspond to said specific data; and
means for executing a processing for enabling said first user to read said specific data.

27. The center system as set forth in claim 26, wherein said means for executing comprises means for transmitting hash data, which is registered in said data storage unit so as to correspond to said specific data, to a terminal of said first user.

28. A center system, comprising:
means for receiving a first digital signature for specific data from a terminal of a user;
means for comparing the received first digital signature with a second digital signature, which is registered in a data storage unit so as to correspond to said specific data; and
means for carrying out a setting to grant said user an authority to update said specific data, if it is judged that said first digital signature and said second digital signature are identical.

29. The center system as set forth in claim 28, further comprising:
means for generating first hash data from said first digital signature, if it is judged that said first digital signature and said second digital signature are not identical;
means for comparing said first hash data with second hash data, which is registered in said data storage unit so as to correspond to said specific data; and
means for carrying out a setting to grant said user an authority to read said specific data, if it is judged that said first hash data and said second hash data are identical.

30. The center system as set forth in claim 29, further comprising means for transmitting an access denial notice to said terminal of said user, if it is judged that said first hash data and said second hash data are not identical.

31. The center system as set forth in claim 28, further comprising:
means for generating, if data for updating said specific data is received from said terminal of said user, third hash data for the updated specific data;
means for transmitting said third hash data to said terminal of said user;
means for receiving a third digital signature generated from said third hash data, from said terminal of said user; and
means for registering said updated specific data, said third hash data, and said third digital signature into said data storage unit.

32. The center system as set forth in claim 31, further comprising:
means for generating fourth hash data from said third digital signature before said registering; and
means for comparing said fourth hash data with said third hash data, and
wherein said means for registering operates if it is judged that said fourth hash data and said third hash data are identical.

33. The center system as set forth in claim 29, further comprising means for transmitting said specific data in a state where only reading is enabled, to said terminal of said user, if said authority to read said specific data is granted to said user.
